(19) United States
(12) Patent Application Publication
(10) Pub. No.: US 2016/0378078 A1
(43) Pub. Date: Dec. 29, 2016

(54) Triggering an Auto-Tuning Function of a PID Controller

(71) Applicants: Steffen Lamparter, Feldkirchen (DE); Raffaello Lepratti, Nurnberg (DE); Dragan Obradovic, Ottobrunn (DE); Lingyun Wang, Princeton, NJ (US)

(72) Inventors: Steffen Lamparter, Feldkirchen (DE); Raffaello Lepratti, Nurnberg (DE); Dragan Obradovic, Ottobrunn (DE); Lingyun Wang, Princeton, NJ (US)

(21) Appl. No.: 14/754,264

(22) Filed: Jun. 29, 2015

(51) Int. Cl. G05B 13/04

(52) U.S. Cl. CPC G05B 13/041

(57) ABSTRACT

A method for initializing an optimization function for parameters of a controller controlling a controlled system is provided. The controlled system includes at least one sensory component and at least one actuator component. The method includes receiving process data over time of the controller, determining a value of at least one prior specified key performance indicator (KPI) of the controller, and identifying a model of the controlled system. The method also includes comparing the at least one determined KPI value with at least one provided former KPI value, and comparing the identified model with at least one provided former model in the case of any significant difference between said values. The method includes initializing an optimization function of the controller parameters by using the determined KPI values as a cost function in the case of any significant difference between the models.

### BACKGROUND

The present invention relates generally to optimizing parameters of a PID controller controlling a control loop/system between at least one sensory component and at least one actuator component. The disclosed technology may be applied to, for example, various automated production environments where programmable controllers are used.

A programmable logic controller (PLC) is a specialized computer control system configured to execute software that continuously gathers data on the state of input devices to control the state of output devices. A PLC may include three major components: a processor (which may include volatile memory), volatile memory including an application program, and one or more input/output (I/O) ports for connecting to other devices in the automation system.

PLCs are utilized in various industrial settings to control automation systems. Automation systems may generate a large amount of data during daily operations. This data may include, for example, sensor data, actuator and control program parameters, and information associated with service activities.

Additionally context knowledge about the process available on control level is lost for the business analytics applications. A great deal of effort is required to rebuild such context knowledge at higher layers of the automation system. For example, the implementation of higher level software functionality in Supervisory Control and Data Acquisition (SCADA), Manufacturing Execution Systems (MES), or Enterprise Resource Planning (ERP) systems becomes much more complicated and costly. In turn, this leads to higher development and customization costs of these solutions. For example, a valve control program for controlling coolant flow until tank temperature reaches a certain level is considered. There is a certain correlation between coolant flow rate and temperature decrease (with some delay). To detect such correlations (which may be utilized for predictive process monitoring on business layer), a pair wise correlation analysis using hundreds of parameters is used.

PLCs execute control programs that are typically a mixture of logic statements and of commands for closed-loop control usually implemented as proportional integral derivative (PID) controllers.

Auto-tuning of the PID controller parameters is typically started manually by an operator. The tuning is performed manually after an error message. In addition, the tuning may be restricted to PID controllers where the tuning process addresses the key performance indicators (KPI) (e.g., hard-wired in the algorithm).

### SUMMARY AND DESCRIPTION

The scope of the present invention is defined solely by the appended claims and is not affected to any degree by the statements within this summary.

The present embodiments may obviate one or more of the drawbacks or limitations in the related art. For example, one or more of the above shortcomings and drawbacks are addressed and overcome by providing methods, systems, and apparatuses configured to trigger an auto-tuning function of the PID controller.

An aspect is a method for initializing or triggering an optimization or an auto-tuning function for parameters of a controller controlling a controlled system. The controlled system includes at least one sensory component and at least one actuator component.

The method includes receiving process data over time of the controller (PID)). determining a value of at least one prior specified key performance indicator (KPI) of the controller (PID), and identifying a model of the controlled system. The method also includes comparing the at least one determined KPI value with at least one provided former KPI value, and comparing the identified model with at least one provided former model in the case of any significant difference between the values. Optionally, a trend of KPIs and statistics of the KPIs are calculated prior to the termination of the method. An optimization function of the controller parameters is initialized by using the determined KPI values as cost function in the case of any significant difference between the models. Optionally, controller internal problem initiates appropriate error handling prior to the termination of the method.

The method may be applied in repetitive automation processes. This technology is well-suited for, but not limited to, various industrial automation settings.

The controller function may be extended. For every batch, the method calculates the KPIs and may also estimate the model of the Controlled System.

The provided former model of the controlled systems may come from a storage including a history of previous estimated models of the controlled system.

At least one determined/calculated KPI value may exceed a predefined threshold or deteriorate over time.

The controller contains a logic that enables a root cause analysis of possible problems leading to unsatisfactory KPI values.

Provided former KPI value may come from a storage including a history of previous used KPI values.

Process data over time may contain time series of the controller input- and/or output values and may be specified within a time window.

The above-mentioned logic automatically triggers the tuning/optimization of the control parameters of the controller.

Maintenance of controllers (and plants/production lines/technical devices) is simplified, and the corresponding manual effort for adjusting control application to changes in the underlying technical system is reduced.

A further aspect is an apparatus for initializing an optimizing function for the parameters of a controller controlling a controlled system. The controlled system includes at least one sensory component and at least one actuator component. The apparatus includes an interface component for receiving process data over time of the controller (PID), and a calculation component for determining a value of at least one prior specified key performance indicator (KPI) of the controller (PID). The apparatus also includes an identification component for identifying a model of the controlled system, and an analysis component for comparing the at least one determined KPI value with at least one provided former KPI value. The analysis component is also for comparing the identified model with at least one provided former model in the case of any significant difference between the values. The apparatus also includes an interface component for initializing an optimization function of the controller parameters by using the determined KPI values as cost function in the case of any significant difference between said models. The calculation component, the identification component, the analysis component, or any combination thereof may be formed by one or more processors.

A further aspect is a computer program product or a computer program directly loadable into the internal memory of a computer and/or of a controller, including software code portions for performing the acts of a method of one or more of the present embodiments when the computer program product is running on a computer/controller. In one embodiment, a non-transitory computer-readable storage medium stores instructions that are executable by one or more processors to perform the acts of a method of one or more of the present embodiments.

Presented embodiments of the method may be applied for the apparatus and the computer program product in an analogue manner.

### BRIEF DESCRIPTION OF THE DRAWINGS

The foregoing and other aspects of the present invention are best understood from the following detailed description when read in connection with the accompanying drawings.

FIG. 1 provides schematically one embodiment of a control loop of a PLC integrated into an industrial environment;

FIG. 2 illustrates exemplary system components included in a PLC;

FIG. 3 is a flowchart illustrating data processing performed by the PLC, according to an embodiment.

### DETAILED DESCRIPTION

Systems, methods, and apparatuses that relate generally to a programmable logic controller (PLC) configured to store and analyze data on the PLC itself, rather than requiring external devices for storage and processing, are described herein. The technology described herein may be applied in a variety of settings where control systems are used including, for example, industrial production environments. An example for a PLC architecture is described in U.S. Ser. No. 14/467,125.

The PLC offers several technical features that may be present in various combinations, according to different embodiments of one or more of the present embodiments. The PLC provides efficient data storage on control layer devices. More specifically, selected of the control layer may be extended by an efficient storage mechanism for time series data (e.g., a “historian” function) that allows short-/mid-term archiving of high resolution time-stamped data. With high fidelity data, few, if any, events are lost. Efficient compression algorithms (e.g., a variation of swinging door) may be used to reduce storage and communication demands. The PLC may also offer an intelligent on-device data generation method. Methods for data filtering may be applied directly where data is generated to provide that additional data is only stored if the additional data provides additional information content. These methods may also actively analyze incoming data and configure data acquisition according to the current needs, for example, by adjusting the sample rate or by storing data only if certain events have been detected. The PLC may also enable rich and semantic contextualization, and perform control layer semantic analytics. Additionally, in some embodiments, the PLC also provides distributed analytics across automation systems.

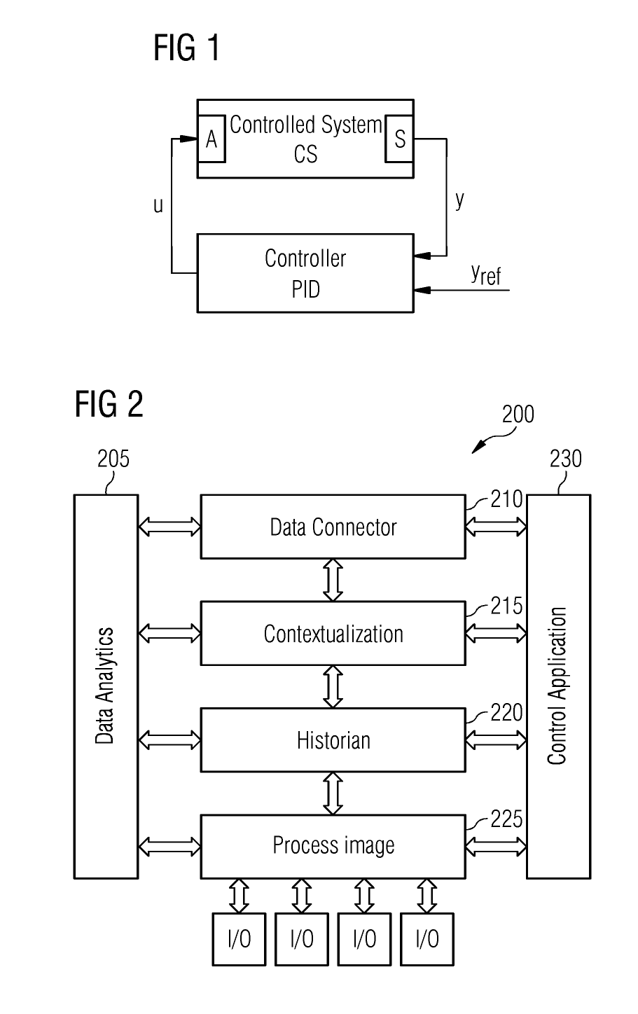

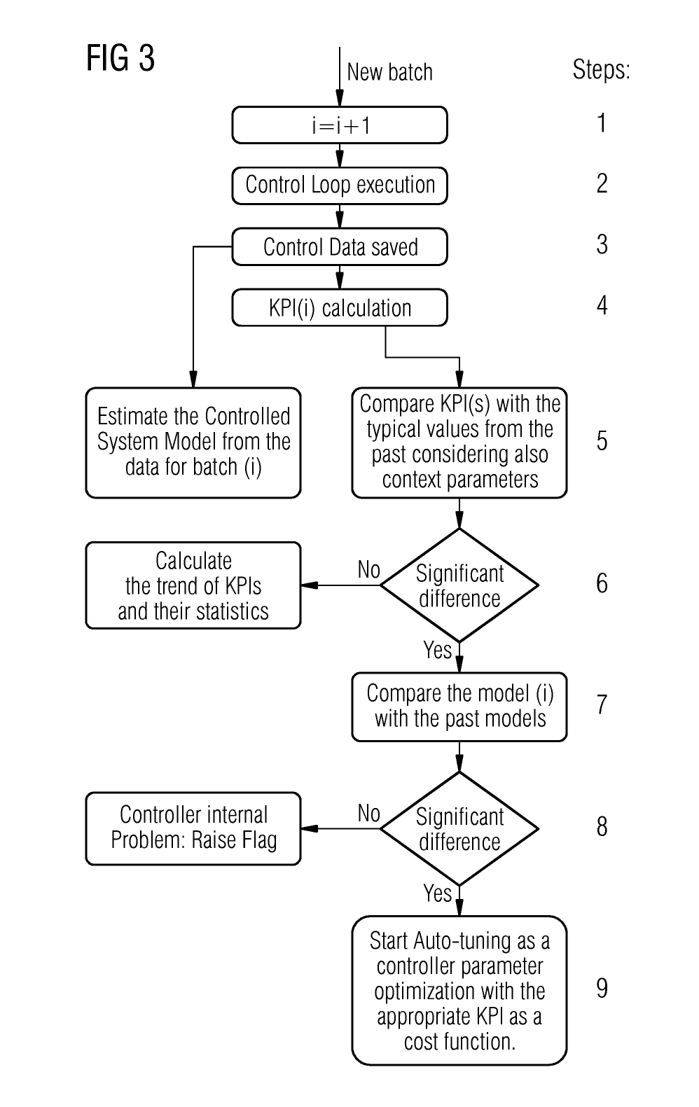

FIG. 1 shows one embodiment of a control loop with a controller PID (e.g., a PID controller) and a controlled system CS including sensors S and actuators A. The sensory information y is received by the controller PID, which then generates the control signal u. The signal yref is a reference signal provided by the algorithm describe in FIG. 3 for optimizing the controller parameters.

The system for realizing the control optimization method described above may be an application running on the PLC, which is described in FIG. 2.

FIG. 2 provides an illustration of exemplary system components 200 included in the PLC. Process Image Component 225 is a memory area in a CPU volatile system memory of a controller that is updated in each processing/scan cycle based on data associated with the production devices (e.g., the inputs and outputs of connected I/Os). In each processing act, the Control Application 230 reads the process image, executes deployed application logic, and writes results back into the process image. Any data captured or generated by the system components 200 may be provided to external components via a Data Connector component 210. In some embodiments, the Data Connector Component 210 delivers data via a push methodology (e.g., actively sending to external component). In other embodiments, a pull methodology may be used where data is queried by external component. Additionally, push and pull methodologies may be combined in some embodiments such that the PLC is configured to handle both forms of data transfer.

Continuing with reference to FIG. 2, the process image of each cycle is read and permanently stored on a non-volatile physical storage medium by the Historian Component 220. In some embodiments, this Historian Component 220 is configured to deploy data compression algorithms to reduce data volume. The Historian Component 220 may thereby provide applications with access to past process images. Data may be stored either for a fixed time window, or online algorithms are used to realize dynamic caching heuristics. As part of the Historian Component 220, intelligent data generation algorithms may continuously analyze the process image and context to adjust data generation parameters (e.g., sampling rate) of connected I/Os. For example, for fast changing sensor signals, a high sampling rate may be selected, while for slowly changing sensor signals, a lower sampling rate is sufficient. The Data Analytics Component 205 includes a set of data analysis algorithms that process the current or past process images (e.g., queried from the historian). Various data analysis algorithms may be included in the Data Analytics Component 205. For example, in some embodiments, these algorithms include one or more of clustering, classification, logic-based reasoning, and statistical analysis algorithms. Algorithms may be specified via a model that may be deployed during runtime on the device. The Data Analytics Component 205 may also include various analytical models and dedicated algorithms to interpret these models. The results generated by the Data Analytics Component 205 may be stored in the Historian Component 220, written back to the Process Image Component 225, and/or provided to external components via the Data Connector Component 210. Thus, the PLC may be viewed as a device for providing distributed analytics to the other devices in the automation system.

A Contextualization Component 215 annotates incoming data with context information to facilitate later interpretation of the incoming data. Context information, as used herein, may include any information that describes the meaning of data. For example, context of data in automation systems may include information about the device that generated the data (e.g., a sensor), about the structure of the automation system (e.g., topology of a plant), about the working mode of the system (e.g., downtime event), about the automation software and a status of the automation software while the data was generated, and/or about the product/batch that was produced while the data was generated. The Contextualization Component is configured to provide data to any of the other components for more specific processing needs. The context information generated by the Contextualization Component 215 may not be restricted to the asset structure but may also include control knowledge, product-specific information, process information, event information, and potentially other aspects such as external events like weather information. Some context information may be imported from engineering tools (e.g., Siemens Totally Integrated Automation tools). Additionally, in some embodiments, the Contextualization Component 215 provides semantic contextualization. The context may be represented by a standard modeling language (e.g., Web Ontology Language, Resource Description Framework), where the meaning of the language constructs is formally defined. Contextualization of data with these semantic modeling standards enables business analytics applications to automatically understand and interpret the data provided from the automation system without manual configuration effort.

It is assumed that a PLC in this context provides the following functionalities. There is a built-in historian (e.g., a database) including time series of the controller input and output values as well as other process data over time. KPIs for each controller (e.g., PID) are defined. The historian also includes the calculated values of KPI over different batches (e.g., car chassis served by the control system) within a specified time window. Method acts are provided for identifying a model of the controlled systems from the available time series in the historian. The model may be linear. According to FIG. 1, the input of the controller is the sensory output of the controlled system, and the controller output is the input for the actuator of the controlled system. Method acts are provided for calculating the prior specified KPIs of the controller (e.g., settling time, number of oscillations in the time response, etc.), which is part of the control loop for the controlled system. Method acts are provided for auto-tuning the controller parameters. Auto-tuning herein is defined as an optimization task over the control parameters with the above mentioned KPI used as cost functions.

The method acts for described auto-tuning are implemented within the Data Analytics component 205. The time series data is acquired from the process image 225 and stored in the Historian component 220. The KPI model is specified by the contextualization component 215. Results of the auto-tuning algorithm (e.g., reconfiguration of a PID controller) are implemented using the Data Connector 210 and the Control Application 230.

FIG. 3 provides a flowchart illustrating the data processing performed by the PLC, according to one or more of the present embodiments.

A method for triggering or initializing auto-tuning/optimizing parameters of the above mentioned controller includes the following acts.

The method is an iterative process that starts with the initial act (i=0) and then with potential following acts: act 1, i=i+1; act 2, control loop execution; act 3, control data saved and estimate the controlled system model from the data for batch(i) and so on, until the process terminates.

For every new batch, the control KPIs will be checked (see acts 4 and 5) and compared with historical values (see act 5). At the moment, when a significant deviation of the controller performance (e.g., based either on a prior defined or “learned” threshold) is observed and no justification of this phenomenon is provided by the context-based interpretation system, an error in the control loop is assumed. The error may stem either from the controller itself or from the change in the controlled system (e.g., including sensor and actuator dynamics). In order to pinpoint the origin of this error, the current estimate of the plant model (e.g., performed either regularly or when necessary) will be compared with the past models (see act 7). If these models differ substantially (see act 8), this is an indication that the dynamics of the system that is controlled has changed. In this case, the fine tuning of the parameters of the controller (e.g., PID controller) will be initialized (see act 9).

In the context of a batch chemical process, the KPI, for example, is represented as the integral (e.g., sum over time) of the error of following a temperature reference profile that is to be below a threshold. The controller may be a PID or any other controller with a parameterized structure that is provided. The parameters of the model of this chemical process are identified at the end of every batch.

If the KPI exceeds the threshold and if the change in the process model (e.g., in the process dynamics) is detected, the parameters of the controller are fine-tuned through an optimization that simulates the dynamics of the process using a current model and the KPI as cost function. The controller parameters are free optimization variables.

The above mentioned example may be extended to time continuous processes where the system dynamics are modeled in regular time intervals. In addition, this scheme is also valid for factory automation processes such as the car assembly lines.

The elements and features recited in the appended claims may be combined in different ways to produce new claims that likewise fall within the scope of the present invention. Thus, whereas the dependent claims appended below depend from only a single independent or dependent claim, these dependent claims may, alternatively, be made to depend, in the alternative, from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for initializing an optimization function for parameters of a controller controlling a controlled system, the controlled system comprising at least one sensory component and at least one actuator component, the method comprising:
receiving process data over time of the controller;
determining a value of at least one prior specified key performance indicator (KPI) of the controller;
identifying a model of the controlled system;
comparing the at least one determined prior specified KPI value with at least one provided former KPI value;
comparing the identified model with at least one provided former model based on the comparison of the at least one determined prior specified KPI value and the at least one provided former KPI value; and
initializing an optimization function of the controller parameters, the initializing comprising using the at least one determined prior specified KPI value as cost function in response to a result of the comparing of the identified model and the at least one provided former model.

2. The method of claim 1, wherein in the comparing of the at least one determined prior specified KPI value with the at least one provided former KPI value, the at least one determined prior specified KPI value exceeds a predefined threshold or deteriorates over time.

3. The method of claim 1, further comprising calculating a trend of KPIs and statistics of the KPIs.

4. The method of claim 1, wherein a controller internal problem initiates appropriate error handling.

5. The method of claim 1, wherein the process data over time includes a time series of controller input values, controller output values, or controller input and output values.

6. The method of claim 1, wherein the process data over time is specified within a time window.

7. The method of claim 1, wherein the at least one provided former KPI value is from a storage including a history of previously used KPI values.

8. The method of claim 1, wherein the at least one provided former model of the controlled system is from a storage including a history of previous estimated models of the controlled system.

9. An apparatus for initializing an optimizing function for parameters of a controller controlling a controlled system, the controller system comprising at least one sensory component and at least one actuator component, the apparatus comprising:
an interface component operable to receive process data over time of the controller;
a processor configured to:
determine a value of at least one prior specified key performance indicator (KPI) of the controller;
identify a model of the controlled system;
compare the at least one determined prior specified KPI value with at least one provided former KPI value; and
compare the identified model with at least one provided former model in response to a result of the comparison of the at least one determined prior specified KPI value and the at least one provided former KPI value; and
an interface component operable to initialize an optimization function of the controller parameters, the initialization comprising use of the at least one determined prior specified KPI value as cost function in response to a result of the comparison of the identified model and the at least one provided former model.

10. The apparatus of claim 9, wherein the at least one determined prior specified KPI value exceeds a predefined threshold or deteriorates over time.

11. The apparatus of claim 9, wherein the processor is further configured to calculate a trend of KPIs and statistics of the KPIs.

12. The apparatus of claim 1, wherein the processor is configured to initiate appropriate error handling for a controller internal problem.

13. The apparatus of claim 9, wherein the process data over time includes a time series of controller input values, controller output values, or controller input and output values.

14. The apparatus of claim 9, wherein the process data over time is specifiable within a time window.

15. The apparatus of claim 9, wherein the at least one provided former KPI value is from a storage including a history of previous used KPI values.

16. The apparatus of claim 9, wherein the at least one provided former model of the controlled system is from a storage including a history of previously estimated models of the controlled system.

17. In a non-transitory computer-readable storage medium that stores instructions executable by one or more processors to initialize an optimization function for parameters of a controller controlling a controlled system, the controlled system comprising at least one sensory component and at least one actuator component, the instructions comprising:
receiving process data over time of the controller;
determining a value of at least one prior specified key performance indicator (KPI) of the controller;
identifying a model of the controlled system;
comparing the at least one determined prior specified KPI value with at least one provided former KPI value;
comparing the identified model with at least one provided former model based on the comparison of the at least one determined prior specified KPI value and the at least one provided former KPI value; and
initializing an optimization function of the controller parameters, the initializing comprising using the determined KPI values as cost function in response to a result of the comparing of the identified model and the at least one provided former model.
